(19) United States
(12) Patent Application Publication
(10) Pub. No.: US 2025/0118142 A1
(43) Pub. Date: Apr. 10, 2025

(54) IMMERSIVE CONTENT CONTROLLER

(71) Applicant: Interblock d.o.o., Menges (SI)

(72) Inventor: John Joseph Connelly, Las Vegas, NV (US)

(21) Appl. No.: 18/896,713

(22) Filed: Sep. 25, 2024

Related U.S. Application Data
(60) Provisional application No. 63/588,982, filed on Oct. 9, 2023.

(51) Int. Cl. G07F 17/32

(52) U.S. Cl. CPC G07F 17/3213; G07F 17/3216; G07F 17/323

(57) ABSTRACT

Improved techniques for gaming cabinet design include synchronizing animations across a plurality of displays positioned around the gaming cabinet. Synchronization of animation and/or linked curved shapes of the display may provide an improved immersive experience for both players at and observers of gaming stations in the cabinet.

### CROSS REFERENCE TO RELATED APPLICATIONS

This application claims benefit under 35 U.S.C. § 119 (e) of Provisional U.S. Patent Application No. 63/588,982, filed Oct. 9, 2023, the contents of which is incorporated herein by reference in its entirety.

### BACKGROUND

Casinos often provide a venue for many players to simultaneously play a variety of different games. The spatial arrangement of these games within a physical space, such as a single room in a casino, may be organized in a variety of ways. Players may discover game games while wandering through a casino space. Various signage around the games including lighting and sound effects may help players discover game playing opportunities, and this signage can also add to an ambiance and player interest in a particular game and the casino overall. Improvements in the physical arrangement and signage of games within a casino may provide improved player experiences at the casino.

### SUMMARY

In accordance with aspects of the present disclosure, a gaming system may comprise a multi-station cabinet and a content controller. The multi-station cabinet may include a plurality of game stations, each with a corresponding player location, a plurality of primary attraction displays, each corresponding to a game station of the plurality of games stations and positioned to be visible by a plyer in the player location of the corresponding game station, a plurality of side attraction displays, each positioned between neighboring games stations of the plurality of game stations, and a display controller generating animated images and providing the animated images to the plurality of primary attraction displays and plurality of side attraction displays. The content controller may include a processor and instructions to cause the content controller to receive game-related information from a game data source and send instructions to the display controller to synchronize a selected animation across primary attraction displays and side attraction displays based on the game-related information.

Synchronized animations across the attraction displays based on the game-related information may provide an improved and immersive experience for players at the game stations, entertainment for observers near the gaming stations, and game discovery for potential players near the gaming stations.

In an aspect of some implementations, an improved immersive experience may be provided by the shape of the attraction displays. For example, the primary attraction displays may have a concave curved shape where a center of the primary attraction displays is closer to a center of the multi-station cabinet and further from a corresponding player location as compared to side edges of the primary attraction displays. The side attraction displays may have a convex curved shape where a center of the side attraction displays is further from the center of the multi-station cabinet as compared to side edges of the side attraction displays. In an aspect, the side edges of the primary side displays meet the side edges of the corresponding neighboring primary attraction displays. The result may create an effect whereby the primary attraction displays and side display of the multi-station cabinet visually appear to be one large display wrapped around the multi-station cabinet.

In other aspects, the multi-station cabinet may further include one or more speakers, and the display controller may provide audio to the one or more speakers, wherein the audio is synchronized with the animated images. The gaming stations may each include a game display for a player to play a game at the corresponding games station. The game data source may include one or more of: an external data source, a game controller of a game station of the plurality of games stations; a game controller of an additional multi-station cabinet. The game-related information may include one or more of: an indication of which of the plurality of game stations are active; a game type available at the plurality of game stations; current bets on games at the plurality of games stations; winning events for games at the plurality of game stations; and currently progressive values for progressive games.

In some implementations, the content controller may be configured to synchronize content across a plurality of multi-station cabinets.

### BRIEF DESCRIPTION OF THE DRAWINGS

Embodiments of the present disclosure will be described more fully hereinafter with reference to the accompanying drawings, in which:

FIG. 1 is a top-down view of an example gaming cabinet.

FIG. 2 is a top-down view of an example arrangement of a collection of gaming cabinets.

FIG. 3 is a schematic view of an example gaming system with two gaming cabinets.

FIG. 4 depicts an example method for controlling content.

FIG. 5 depicts an example controller system.

### DETAILED DESCRIPTION

The present disclosure describes techniques for providing an improved experience in a casino, including providing improved discovery of available games and game events, improved casino ambiance, and improved entertainment for game observers. The improved experiences may be provided by game-related content presented in a synchronized manner across multiple displays and/or speakers. The game-related content may indicate which games are available at game stations, game events such as a big win at a game station, and/or currently progressive win jackpot values of progressive games that span multiple games stations.

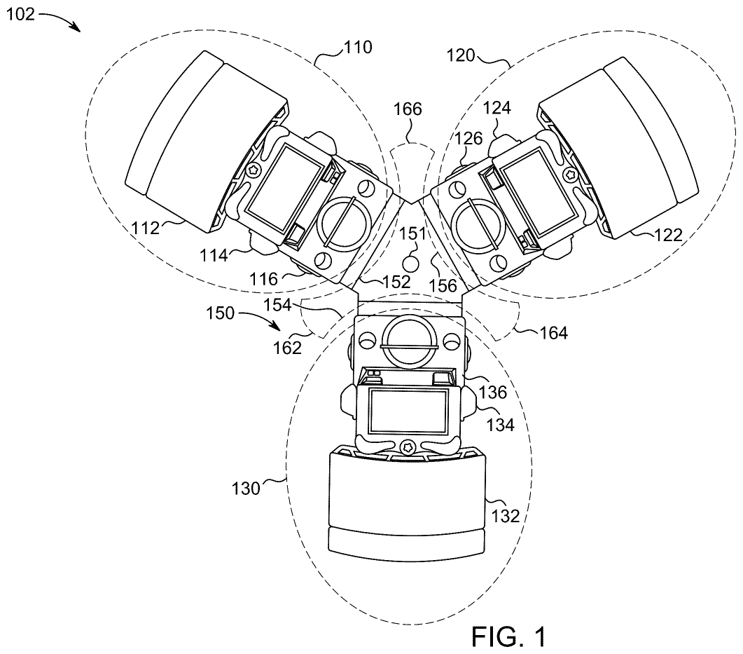

FIG. 1 is a top-down view 100 of an example gaming cabinet 102. Gaming cabinet 102 is multi-station cabinet including game stations 110, 120, 130 positioned around an attraction display 150. Game stations 110, 120, 130 each respectively includes a player location 112, 122, 132, a game controller 114, 124, 134, and a game user interface 116, 126, 136. The player locations 112, 122, 132 may include, for example a seat positioned such that a player seated on the seat may interact with the corresponding game user interface 116, 126, 136. Game user interfaces 116, 126, 136 may include, for example a game display, game speaker, secure player identification input, a device to input casino credits and receive winnings, and further include other mechanical physical elements for a particular game available at the game stations, such as cards for card-type games, wheel and balls for roulette-type games, or dice for dice-type games. Game controllers 114, 124, 134 may include a processor for receiving input from and providing output to from the corresponding game user interface 116, 126, 136, and for providing game-related information to a content controller (not depicted in FIG. 1).

Attraction display 150 may include primary displays 152, 154, 156 and side displays 162, 164, 166. Attraction display may be positioned over a center 151 of the cabinet 102, and each primary display 152, 154, 156 may be positioned in front of a corresponding gaming station 110, 120, 130 such that the primary display is visible from a player positioned at the corresponding player location 112, 122, 132 as well as visible to other observers generally in the area of cabinet 102.

In an aspect of some implementations, primary displays 152, 154, 156 may have a curved concave shape with a center of the primary displays closer to a center 151 of the cabinet 102 than the side edges of the displays. The curved concave shape of each primary display 152, 154, 156 wraps around a front portion of the game stations 110, 120, 130 so as to immerse the user's visual experience into the game in a manner that cannot be created by a flat display or a less curved display. Meanwhile side displays 162, 164, 166 may have an opposite curved convex shape with a center of the side displays further from the center 151 than the side edges of the side displays. Concave curves in the primary displays may allow tighter packing of gaming stations within a casino, while convex curves of the side display may allow players at neighboring stations to better view content presented on the side displays. In other aspects, the displays may be positioned such at any visual gap between primary displays and their neighboring side displays is minimized to create a visual impression that all primary and side displays in the cabinet form a single undulating display wrapped around the cabinet 102. In another aspect, primary and side displays may have a straight shape vertically stretching from the casino flow toward the casino ceiling.

In an aspect, cabinet 102 may also include a display controller for the attraction displays, one or more attraction speakers, and a content controller, none of which are depicted in FIG. 1.

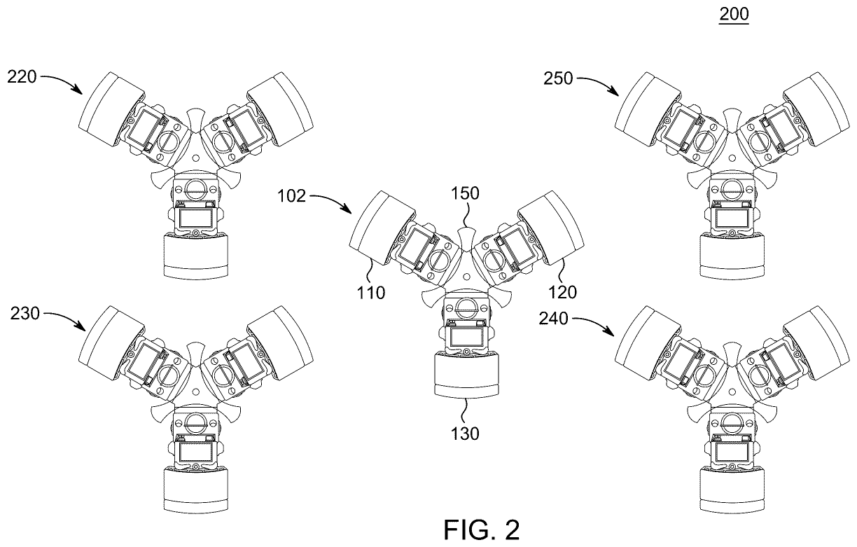

FIG. 2 is a top-down view 200 of an example arrangement of a collection of five gaming cabinets. In the example of FIG. 2, each gaming cabinet 102, 220, 230, 240, and 250 includes three games stations and an attraction display (such as at game stations 110, 120, 130 and attraction display 150 of gaming cabinet 102).

FIGS. 1 and 2 depict gaming cabinets, each with three game stations. However, implementations of the improved techniques are not so limited. Other gaming cabinets may include two, four, five, or more game stations. For example, a two-station game cabinet may include two stations on opposite sides of the cabinet, or some other angle other than 180 degrees relative to one another, with a relatively larger side display than is depicted in FIG. 1. A four-station cabinet may have stations arranged in a square, and a five-station cabinet may have stations arranged in the shape of a pentagon. In some cases, a group of gaming cabinets having different numbers of stations may be controlled by a single content controller.

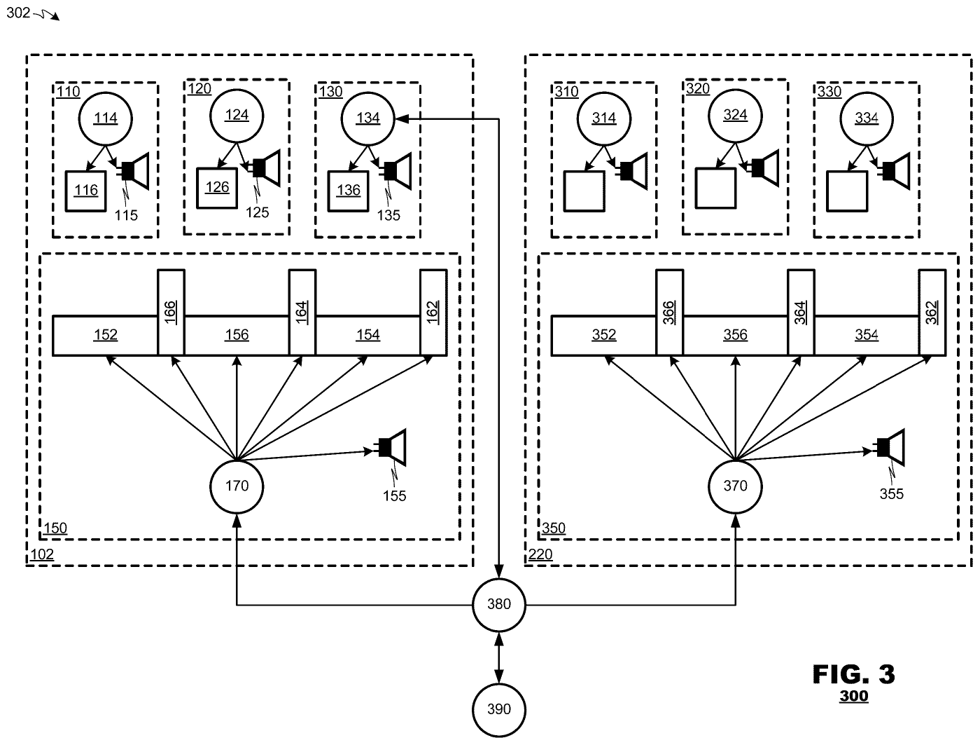

FIG. 3 is a schematic view 300 of an example gaming system 302 with two gaming cabinets 102, 220 connected to a network. Gaming system 302 includes an external source 390 of game-related information, a content controller 380, display controllers 170, 370, game controllers 111, 121, 131, 311, 321, 331. Lines connecting the external source and the various controllers in FIG. 3 may indicate communicative couplings, while the arrowheads indicate an example direction of information flow. The arrowheads do not indicate a restriction to one-directional communication within the gaming system 302. While only one line is shown connecting content controller 380 and game controller 131 for simplification of the drawings, similar connection lines would exist between content controller 380 and game controllers 111, 121, 311, 321, 331.

Gaming system 302 additionally includes game stations 110, 120, 130 and attraction display 150 in cabinet 102 and game stations 310, 320, 330 and attraction display 550 in cabinet 220. Attraction display 150 may include primary displays 152, 156, 154, side displays 166, 164, 162, and speaker 155. Attraction display 350 may include primary displays 352, 356, 354, side displays 366, 364, 362, and speaker 355. Game stations 110, 120, 130, 310, 320, 330 may each include a corresponding game controller and game user interface, which may include a game display and game speaker. For example, game stations 110, 120, 130 include game user interface 116, 126, 136, that each includes a game display (not separately shown), and game speaker 115, 125, 135.

External source 390 may provide game-related information as well as display information, player information, progressive information, etc. The content controller 380 may determine which of the cabinets 102, 220 receive the information from external source 390. Likewise, display controllers 170, 370 may determine which of the primary displays 152, 156, 154, 352, 256, 254 and side display 166, 164, 162, 366, 364, 362 will receive the information from the content controller 380. As noted, each of the game controllers 111, 121, 131, 311, 321, 331 communicate data with the content controller 380 that may then be used to control the content to be delivered to each of the game stations and the primary and side displays.

External source 390 may serve display data to each of the display controllers 170, 370 that enable each of the display controllers to display the same content, i.e., communal content, on each of the primary and side displays at the same time or in synchronization between them based on how the cabinets 102, 220 are physically situated relative to one another. For example, while one or more cabinets are not in use, or in-between games, communal display data may be served to the primary and side displays in a way that causes video to be displayed on each of the cabinets are the same time, or for video data to move from one cabinet to another cabinet such that the displayed images appear to move from one cabinet to the next. However, when the cabinets are in use or during a game, only game display data associated with that cabinet and the game being played on the cabinet is displayed. Further, while game display data may be displayed on the primary display, the side displays may still be displaying communal information. Sound generated at each of the cabinets may also be similarly communal and local and synchronized between cabinets.

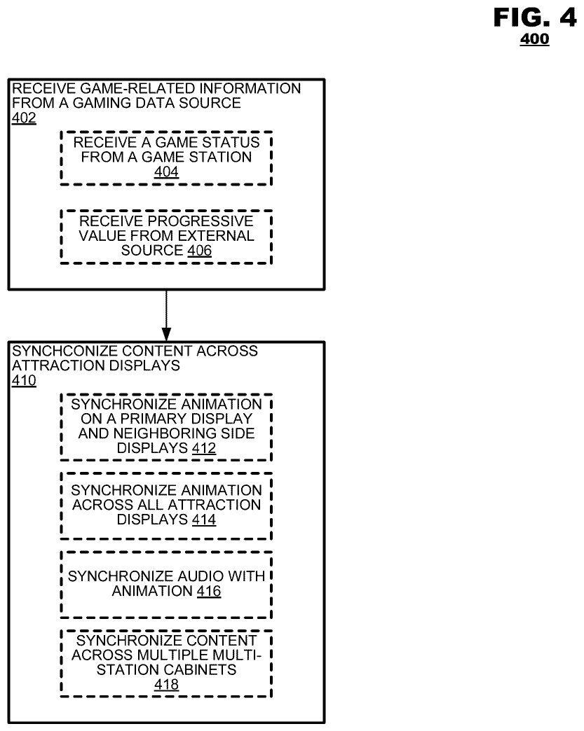

FIG. 4 depicts an example method 400 for controlling content. Method 400 may be performed by a content controller, such as content controller 380, (FIG. 3). Method 400 includes receiving game-related information from a gaming data source (402), and then synchronizing content across a plurality of attraction displays (410).

In an aspect, game-related information may include one or more of: an indication of which of the plurality of game stations are active (e.g., gaming stations 1 and 3 are currently active while station 2 is available); a count of active games stations within a gaming cabinet (e.g., two of three total games stations in a gaming cabinet are active), a game type available at the plurality of game stations (e.g., an indication that a craps-type game is available at a first game station in a gaming cabinet and a roulette-type game is available at a second game station in the gaming cabinet); a value of one or more wagers currently placed on game at a games station; events for games at the plurality of game stations (e.g., a first level jackpot winning event, a mega jackpot winning event, or a special game mode has begun); and a current value of a progressive jackpot related to a progressive game played across multiple game stations. An active game station may be, for example, a game station where a player is currently active in a game at that station, or where a player has placed a wager for which a win or loss has not yet been decided.

In another aspect, the gaming data source may include one or more of: an external data source, such as external source 390 (FIG. 3), and a game controller of a game station in any gaming cabinet associated with a content controller, such as controllers 114, 124, 134, 314, 324, 334 (FIG. 3). An external source may include, for example a progressive game controller that sets and/or accumulates a progressive jackpot based on a plurality of game stations, which may include game stations elsewhere in a casino, or in other casinos, and not associated with a local content controller.

In aspects, synchronizing content across displays (410) may include synchronizing an animation or video across more than one display. For example, a content controller may instruct a display controller to generate and synchronize a first win announcement animation across a first primary display and its two neighboring side displays (412) when the content controller receives, from a game station corresponding to the first primary display, an indication of a first level win event occurring in a game at that corresponding game station. In another example, a content controller may instruct a display controller to generate and synchronize a second win announcement animation across all attraction displays in a multi-station cabinet (414) when the content controller receives an indication of a second level win event occurring in a game at any game station in the multi-station cabinet.

In other aspects, synchronized animations may include audio, and a display controller may provide the audio to an acoustic transducer, such as speaker 155 and/or 355 (FIG. 3) such that the audio emitted from the acoustic transducer is synchronized with at least one animation presented on associated attraction displays (416). In some cases, a content controller may be associated with, and control attraction content across, multiple gaming cabinets, and in these cases, synchronizing content across displays (410) may include synchronizing content across multiple multi-station cabinets, including synchronizing the animations across at least one attraction display in two or more cabinets. In some cases, animation synchronization may include synchronizing displays based on the direction the displays are facing. For example, an animation may be synchronized across all displays visible from one location in a casino, while not presenting the synchronized animation on other display not visible from the one location in the casino.

In some examples, synchronization of content (410) may include starting an animation on multiple attraction display simultaneously (at the same time). In other example, synchronization of content may include starting an animation at related but different times on different displays. For example, a content controller may instruct a display controller to start an animation at a first time on a first attraction display of a multi-station cabinet, and then the content controller may instruct the display controller to present the same animation starting at a second time (e.g., two seconds after the first time) on a second attraction display neighboring the first attraction display. The same animation may subsequently start at subsequent starting times in a wave moving around the attraction displays in a multi-station cabinet.

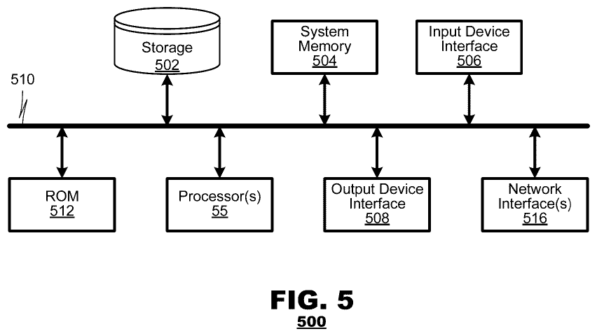

FIG. 5 illustrates an example computing device 500 with which aspects of the subject technology may be implemented in accordance with one or more implementations. For example, device 500 may be an implementation of one or more controllers within the gaming cabinets of FIGS. 1 and 2, and one or more external source 390, controllers 380, 170, 370, 110, 121, 131, 311, 321, 321 (FIG. 3) or a portion thereof, and method 400 (FIG. 5) or a portion thereof may be implemented on computing device 500. The computing device 500 can be, and/or can be a part of, any computing device or server for generating the features and processes described above, including but not limited to a laptop computer, a smartphone, a tablet device, a wearable device such as a goggles or glasses, an earbud or other audio device, a case for an audio device, and the like. The computing device 500 may include various types of computer readable media and interfaces for various other types of computer readable media. The computing device 500 includes a permanent storage device 502, a system memory 504 (and/or buffer), an input device interface 506, an output device interface 508, a bus 510, a ROM 512, one or more processing unit(s) 514, one or more network interface(s) 516, and/or subsets and variations thereof.

The bus 510 collectively represents all system, peripheral, and chipset buses that communicatively connect the numerous internal devices of the computing device 500. In one or more implementations, the bus 510 communicatively connects the one or more processing unit(s) 514 with the ROM 512, the system memory 504, and the permanent storage device 502. From these various memory units, the one or more processing unit(s) 514 retrieves instructions to execute and data to process in order to execute the processes of the subject disclosure. The one or more processing unit(s) 514 can be a single processor or a multi-core processor in different implementations.

The ROM 512 stores static data and instructions that are needed by the one or more processing unit(s) 514 and other modules of the computing device 500. The permanent storage device 502, on the other hand, may be a read-and-write memory device. The permanent storage device 502 may be a non-volatile memory unit that stores instructions and data even when the computing device 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random-access memory. The system memory 504 may store any of the instructions and data that one or more processing unit(s) 514 may need at runtime. In one or more implementations, the processes of the subject disclosure are stored in the system memory 504, the permanent storage device 502, and/or the ROM 512. From these various memory units, the one or more processing unit(s) 514 retrieves instructions to execute and data to process in order to execute the processes of one or more implementations.

The bus 510 also connects to the input and output device interfaces 506 and 508. The input device interface 506 enables a user to communicate information and select commands to the computing device 500. Input devices that may be used with the input device interface 506 may include, for example, alphanumeric keyboards and pointing devices (also called “cursor control devices”). The output device interface 508 may enable, for example, the display of images generated by computing device 500. Output devices that may be used with the output device interface 508 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 510 also couples the computing device 500 to one or more networks and/or to one or more network nodes through the one or more network interface(s) 516. In this manner, the computing device 500 can be a part of a network of computers (such as a LAN, a wide area network (“WAN”), or an Intranet, or a network of networks, such as the Internet. Any or all components of the computing device 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It will be appreciated that the system and methods discussed herein are not limited to the depicted embodiments, and other types of signage and animated displays may be used in the gaming systems to achieve the described features and benefits. While certain embodiments have been described, these embodiments have been presented by way of example only and are not intended to limit the scope of the inventions disclosed herein. Indeed, the present disclosure described herein may be embodied in a variety of other forms; furthermore, various omissions, substitutions, and changes in the form of the embodiments described herein may be made without departing from the spirit of the inventions disclosed herein. The accompanying claims and their equivalents are intended to cover such forms or modifications as would fall within the scope and spirit of certain of the inventions disclosed herein.

We claim:

1. A gaming system, comprising:
a multi-station cabinet including:
a plurality of game stations, each with a corresponding player location;
a plurality of primary attraction displays, each corresponding to a game station of the plurality of game stations and positioned to be visible by a player in the player location of the corresponding game station;
a plurality of side attraction displays, each positioned between neighboring game stations of the plurality of game stations;
a display controller generating animated images and providing the animated images to the plurality of primary attraction displays and the plurality of side attraction displays; and
a content controller including a processor and content controller instructions that cause the content controller to:
receive game-related information from a game data source; and
send instructions to the display controller to synchronize a selected animation across the plurality of primary attraction displays and the plurality of side attraction displays based on the game-related information.

2. The gaming system of claim 1, wherein:
each of the plurality of primary attraction displays have a concave curved shape where a center of the primary attraction displays is closer to a center of the multi-station cabinet and further from a corresponding player location as compared to side edges of each of the plurality of primary attraction displays;
each of plurality of the side attraction displays have a convex curved shape where a center of the side attraction displays is further from the center of the multi-station cabinet as compared to side edges of the side attraction displays; and
the side edges of each of the plurality of the primary side displays meet the side edges of each corresponding neighboring primary attraction display among the plurality of primary attraction display.

3. The gaming system of claim 1, wherein:
the multi-station cabinet further includes one or more speakers;
the display controller provides audio to the speaker, wherein the audio is synchronized with the animated images.

4. The gaming system of claim 1, wherein each of the plurality of game stations further includes:
a gaming controller configured to control a game at the corresponding game station and to provide game-related information to the content controller regarding a state of the game;
a game user interface including a game display.

5. The gaming system of claim 1, further including:
one or more additional multi-station cabinets, each additional multi-station cabinet having additional game stations, additional primary attraction displays, additional side attraction displays, and additional attraction display controllers for providing animations for the corresponding additional primary attraction displays and corresponding additional side attraction displays;
wherein the content controller instructions cause the content controller to:
send an instruction to the additional attraction display controllers of the additional multi-station cabinets to synchronize a selected animation across the additional primary attraction displays and the additional side attraction displays of the additional multi-station cabinets.

6. The gaming system of claim 1, wherein the game data source includes one or more of: an external data source, a game controller of a game station of the plurality of game stations; a game controller of an additional multi-station cabinet.

7. The gaming system of claim 1, wherein the game-related information includes one or more of: an indication of which of the plurality of game stations are active; a game type available at the plurality of game stations; current bets on games at the plurality of games stations; winning events for games at the plurality of game stations; and currently progressive values for progressive games.
